(19) United States
(12) Patent Application Publication
(10) Pub. No.: US 2006/0099318 A1
(43) Pub. Date: May 11, 2006

(54) Non-tea-based, packaged beverages

(75) Inventors: Masaki Iwasaki, Sumida-ku (JP); Naoki Hosoya, Sumida-ku (JP); Shinji Yamamoto, Sumida-ku (JP); Norihiko Satake, Sumida-ku (JP); Eiichi Hoshino, Sumida-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kao Corporation, Chuo-ku (JP)

(21) Appl. No.: 11/258,892

(22) Filed: Oct. 27, 2005

(30) Foreign Application Priority Data
Nov. 4, 2004 (JP) 2004-320045
Nov. 10, 2004 (JP) 2004-325876
Feb. 8, 2005 (JP) 2005-031647

(51) Int. Cl. A23B 7/148; A23L 2/00

(52) U.S. Cl. 426/590; 426/106

(57) ABSTRACT

Provided is a non-tea-based, packaged beverage which includes a sour seasoning, contains catechins at high concentration, and even after stored over along term, can still give a refreshing feeling specific to a sour taste. The non-tea-based, packaged beverage is free of the persistence of a sour taste, which is experienced when taken in sport scenes, and is excellent in mouth refreshment. Even in a form filled in an oxygen-permeable, clear container, the non-tea-based, packaged beverage shows excellent color tone stability. The non-tea-based, packaged beverage contains a purified product of green tea extract added to it. The purified product comprises non-polymer catechins in its solid constituents and has a content weight ratio of (B) oxalic acid to (A) the non-polymer catechins [(B)/(A)] in a range of from 0 to 0.002. The non-tea-based, packaged beverage comprises the following ingredients (A) to (D): (A) from 0.03 to 0.6 wt % of non-polymer catechins, (B) oxalic acid or a salt thereof at an ingredient (B)/ingredient (A) of from 0 to 0.02, (C) caffeine at an ingredient (C)/ingredient (A) weight ratio of from 0 to 0.16, and (D) from 0.03 to 1.0 wt % of a sour seasoning, and has a pH of from 2 to 6.

### FIELD OF THE INVENTION

This invention relates to non-tea-based, packaged beverage, which includes a purified product of green tea extract, contains catechins at high concentration, is excellent in flavor and taste, and is also superb in color tone stability under oxygen permeation.

### BACKGROUND OF THE INVENTION

As effects of catechins, there have been reported a suppressing effect on the increase of cholesterol and an inhibitory effect on α-amylase activity (JP-A-60-156614 and JP-A-03-133928). For such physiological effects to manifest, it is necessary for an adult to drink tea as much as 4 to 5 cups a day. Accordingly, there has been a great demand for a technological method by which catechins can be added to beverages at a high concentration in order to facilitate the ingestion of a large amount of catechins. As one of methods for this, catechins are added in a dissolved form to a beverage by using a green tea concentrate (JP-A-2002-142677, JP-A-8-298930, and JP-A-8-109178) or the like.

On the other hand, commercial beverages which contain a sour seasoning are not sufficient in mouth refreshment due to the persistence of a sour taste when taken in sport scenes.

In a form filled in oxygen-permeable clear containers, they are prone to alterations in external appearance during their storage tests designed on the assumption that they would be on display in shops or stores and would be exposed to lighting, and therefore, are not good in color tone stability when exposed to light under oxygen permeation. It is, therefore, essential for the cut-off of light and oxygen to use oxygen-impermeable, opaque containers, thereby making it impossible to promote the diversification of merchandise.

When a conventional, commercial concentrate of green tea extract is used as is, the resulting non-tea-based, packaged beverage has strong astringency and bitterness under the influence of the components contained in the concentrate of green tea extract and gives a poor feeling as it passes down the throat, so that it is not suited for long-term drinking which is required to develop the physiological effects of catechins. As a method for reducing astringency which is one of elements that make the non-tea-based, packaged beverage unsuited for long-term drinking, on the other hand, there is a method that adds dextrin. Sole reliance on this method is, however, not sufficient when catechins are added at high concentration. Further, it is not preferred to use a commercial concentrate of green tea extract as is in a sweetener-containing beverage, because the concentrate is strong in astringency and bitterness, tends to make a disagreeable aftertaste remain from the middle of taking the beverage, and moreover, has an unnecessary flavor and taste derived from green tea. After the beverage is stored over a long term, a disagreeable aftertaste tends to remain especially after the middle of taking the beverage (JP-A-10-501407). When sold in an oxygen-permeable clear container under lighting, the beverage is susceptible to alteration in external appearance so that its color tone is not stable.

A beverage with a sweetener simply added therein, when taken in the course of playing sports, leaves a disagreeable taste after the middle of taking the beverage, is not good in mouth refreshment, and more, can hardly relieve the thirst. As methods for reducing the sweetness of a beverage, it is known inter alia to adjust the amounts of a sweetener and sour seasoning to be added, to add a bubbling carbonate, and to add a plant flavor. With these methods, however, no lessening has been observed in the problems, although they may be able to reduce the intensity of sweetness. Further, any attempt to lessen the problems by the addition of a sour seasoning in a greater amount conversely leads to a deterioration in taste due to excessively strong pungency.

As a process for the production of low-caffeine tea polyphenols, there is a process that obtains high-purity polyphenols by removing, with a synthetic adsorbent or the like, caffeine to high extent (for example, polyphenol/caffeine ratio: 20,000). However, taste components and bitterness suppressors inherently contained in a tea extract, such as amino acids and pectin, are also removed concurrently with the removal of caffeine. A beverage with such low-caffeine tea polyphenols added therein is not only strong in bitterness and astringency but also unsuitable for long-term drinking (JP-A-10-501407).

### SUMMARY OF THE INVENTION

Described specifically, the present invention provides a non-tea-based, packaged beverage with a purified product of green tea extract added thereto, wherein the purified product contains non-polymer catechins in solid constituents thereof and has a content weight ratio of (B) oxalic acid or a salt thereof to (A) the non-polymer catechins [(B)/(A)] in a range of from 0 to 0.002, and the non-tea-based, packaged beverage contains the following ingredients (A) to (D):

(A) from 0.03 to 0.6 wt % of non-polymer catechins,

(B) oxalic acid or a salt thereof at an ingredient (B)/ingredient (A) of from 0 to 0.02,

(C) caffeine at an ingredient (C)/ingredient (A) weight ratio of from 0 to 0.16, and

(D) from 0.03 to 1.0 wt % of a sour seasoning, and has a pH of from 2 to 6.

The present invention also provides anon-tea-based, packaged beverage with a purified product of green tea extract mixed therein, wherein the purified product extract contains non-polymer catechins in solid constituents thereof and has a content weight ratio of (B) oxalic acid or a salt thereof to (A) non-polymer catechins [(B)/(A)] in a range of from 0 to 0.002, and the non-tea-based, packaged beverage contains the following ingredients (A) to (C) and (E):

(A) from 0.03 to 0.6 wt % of non-polymer catechins,

(B) oxalic acid or a salt thereof at an ingredient (B)/ingredient (A) weight ratio of from 0 to 0.02,

(C) caffeine at an ingredient (C)/ingredient (A) weight ratio of from 0 to 0.16, and

(E) from 0.001 to 15 wt %, in terms of fructose equivalent amount, and from 0 to less than 0.05 wt %, of a carbohydrate; and its production process.

The present invention further provides a non-tea-based, packaged beverage with a purified product of green tea extract added thereto, wherein the purified product contains non-polymer catechins in solid constituents thereof and has a content weight ratio of (F) quinic acid or a salt thereof to (A) non-polymer catechins [(F)/(A)] in a range of from 0 to 0.018, and the non-tea-based, packaged beverage contains the following ingredients:

(A) from 0.03 to 0.6 wt % of non-polymer catechins,

(F) quinic acid or a salt thereof at an ingredient (F)/ingredient (A) weight ratio of from 0 to 0.2,

(I) from 0.0001 to 20 wt % of a sweetener,

(D) from 0.03 to 1.0 wt % of a sour seasoning,

(G) from 0.0001 to 0.2 wt % of sodium ions, and

(H) from 0.0001 to 0.1 wt % of potassium ions, and has a pH of from 2 to 6.

### DETAILED DESCRIPTION OF THE INVENTION

With respect to the above-described problems of beverages which contain a sour seasoning, it has been found that the addition of a concentrate of a green tea extract makes it possible to resolve the problems of a persistent sour taste inherent to the sour seasoning and poor refreshment. On the other hand, it has also become increasingly clear that, when the concentrate of the green tea extract is used as is, problems arise under the influence of certain components contained in the concentrate of the green tea extract such that subsequent to the storage of the beverage over a long term, the refreshing feeling specific to the sour seasoning cannot be persistently given and becomes fuzzy.

The present inventors have also found that a non-tea-based, packaged beverage resolved in these problems can be obtained when a concentrate of a green tea extract is further purified to remove admixed components and the thus-obtained purified product of green tea extract is used. Described specifically, it has been found that the purification of a concentrate of a green tea extract to decrease the content ratio of oxalic acid or a salt thereof to catechins to zero or close to zero and the use of the thus-purified product to adjust the ratios of oxalic acid and caffeine to non-polymer catechins in a beverage and to bring the pH of the beverage to 2 to 6 can provide a packaged beverage which, even after long-term storage with a sour seasoning being included and catechins contained at high concentration, can still give a refreshing feeling specific to a sour taste, which is free of the persistence of the sour taste which is otherwise often experienced especially in sport scenes, and which is excellent in mouth refreshment. In addition, it has also been found that the thus-obtained beverage is excellent in color tone stability even in a form filled in an oxygen-permeable, clear container.

Furthermore, the present inventors have also found that the use of the purified product of the concentrate of the green tea extract and an adjustment of the content of a carbohydrate can provide a non-tea-based, packaged beverage which despite the inclusion of catechins at high concentration, is free of the flavor and taste of green tea and gives practically no feeling of bitterness or astringency, which also allows no disagreeable aftertaste to remain from the middle of taking the beverage even after its long-term storage, which is suited as a thirst-relieving beverage to be taken when water is desired especially while playing sports, and which is excellent in color tone stability even in a form filled in an oxygen-permeable clear container.

It has also been found that the purification of a concentrate of a green tea extract to decrease the content ratio of quinic acid or a salt thereof to catechins to zero or close to zero and the use of the thus-purified product to adjust the ratio of quinic acid to non-polymer catechins in a beverage and to bring the pH of the beverage to 2 to 6 can provide a packaged beverage which, even after long-term storage with a sour seasoning being included and catechins contained at high concentration, can still give a refreshing feeling specific to a sour taste, which is free of the persistence of the sour taste which is otherwise often experienced especially in sport scenes, and which is excellent in mouth refreshment. In addition, the thus-obtained beverage is excellent in color tone stability even in a form filled in an oxygen-permeable, clear container. It has also been found that the beverage is high in the stability of turbidity.

The non-tea-based, packaged beverage according to the present invention, which includes a sour seasoning and contains catechins at high concentration, can still give a refreshing feeling specific to a sour taste even after long-term storage, is free of the persistence of the sour taste which is otherwise often experienced especially in sport scenes, and is excellent in mouth refreshment. In addition, the non-tea-based, packaged beverage is excellent in color tone stability even in a form filled in an oxygen-permeable, clear container. Even in a form filled in oxygen-permeable clear container, its external appearance is hardly altered during its storage test designed on the assumption that it would be on display in a shop or store and would be exposed to lighting, and therefore, is excellent in color tone stability when exposed to light under oxygen permeation. Moreover, the beverage is high in the stability of turbidity.

The non-tea-based, packaged beverage according to the present invention, which includes a carbohydrate and contains catechins at high concentration, is free of the flavor and taste of green tea, gives practically no bitterness and astringency, and even after its long-term storage, hardly allows a disagreeable aftertaste to remain from the middle of taking the beverage. It is suited as a thirst-relieving beverage to be taken when water is desired especially while playing sports or the like, and hardly undergoes an alteration in external appearance during its storage test designed on the assumption that it would be on display in a shop or store and would be exposed to lighting, and therefore, is excellent in color tone stability when exposed to light under oxygen permeation.

The term “non-polymer catechins (A)” as used herein is a generic term, which collectively encompasses non-epicatechins such as catechin, gallocatechin, catechingallate and gallocatechingallate, and epicatechins such as epicatechin, epigallocatechin, epicatechingallate and epigallocatechingallate.

The purified product of green tea extract for use in the packaged beverage according to the present invention is one obtained by conducting purification such that it preferably contains from 20 to 90 wt % of non-polymer catechins in the solid constituents thereof and that (1) the content weight ratio of (B) oxalic acid or its salt to (A) the non-polymer catechins in a concentrate of the green tea extract [(B)/(A)] ranges from 0 to 0.002 or (2) the content weight ratio of (F) quinic acid or its salt to (A) the non-polymer catechins in a concentrate of the green tea extract [(F)/(A)] ranges from 0 to 0.018.

The term “purified product of green tea extract” as used herein includes, in addition to one obtained by further purifying a concentrate of an extract of tea leaves in hot water or a water-soluble organic solvent, one obtained by directly purifying the extract and a purified product of an extract of refined tea leaves.

As the purified product of green tea extract, a purified product of a concentrate of a green tea extract may be used such as commercially-available “POLYPHENON™” (Mitsui Norin Co., Ltd.), “TEAFURAN™” (ITO EN, LTD.) or “SUNPHENON™” (Taiyo Kagaku Co., Ltd.).

Examples of a purification method of a concentrate of a green tea extract include a method which include suspending or dissolving in water or a mixture of water and an organic solvent a concentrate of a green tea extract, said concentrate containing from 20 to 90 wt % of non-polymer catechins in its solid constituents, adding an organic solvent to the thus-prepared suspension or solution, removing the resulting precipitate, and then distilling off the solvent; and a method which includes dissolving a concentrate of a green tea extract in an organic solvent, adding water or a mixture of water and an organic solvent to the thus-prepared solution, removing the resulting precipitate, and then distilling off the solvent. As the organic solvent, a lower alcohol such as methanol, ethanol or isopropanol can be mentioned, with ethanol being preferred.

Further, a concentrate of a tea extract, said concentrate containing from 20 to 90 wt % of non-polymer catechins in its solid constituents, may be purified by dissolving it in a 9.9/1 to 1/9 mixed solution of an organic solvent and water and then bringing the resulting solution into contact with activated carbon and acid clay or activated clay. Furthermore, such a concentrate may also be purified by supercritical extraction or by having it adsorbed on an adsorbent resin, eluting the same with an ethanol solution, and then distilling off ethanol.

As the form of “the concentrate of green tea extract” as used herein, various forms can be mentioned such as a solid, aqueous solution and slurry. An aqueous solution, slurry or the like is more preferred for reduced effects of drying or the like.

In a purified product of green tea extract for use in the present invention, the content weight ratio of (B) oxalic acid or a salt thereof, which may hereinafter be referred to collectively as “oxalic acid”, to (A) non-polymer catechins [(B)/(A)] is from 0 to 0.002, preferably from 0 to 0.0018, more preferably from 0 to 0.0015, still more preferably from 0 to 0.0012, yet more preferably from 0 to 0.001, even more preferably from 0 to 0.0008, still even more preferably from 0.00001 to 0.0008. Upon formulation into a beverage, it is necessary for the manifestation of the advantageous effects of the present invention to control the content of oxalic acid to the above-described range beforehand in the purified product of green tea extract, because oxalic acid may be considered to be mixed in as a beverage ingredient other than the purified product of green tea extract. Insofar as the content weight ratio [(B)/(A)] falls within this range, a refreshing feeling is not rendered fuzzy even after storage over a long term, the persistence of a sour taste which is generally experienced when taken especially in a sport scene is not experienced, and a disagreeable aftertaste which is generally experienced from the middle of taking a beverage especially in a sport scene hardly remains, and therefore, the packaged beverage is excellent in mouth refreshment. Even in a form filled in an oxygen permeable, clear container or even when exposed to lighting over a long term in a shop window, the packaged beverage is resistant to alterations in external appearance. The packaged beverage, therefore, has excellent color tone stability even when exposed to light under oxygen permeation. Outside the above range, the advantageous effects of the present invention cannot be brought about, and moreover, oxalic acid is abundantly introduced from the catechin source into the beverage so that the beverage is rendered unbalanced in flavor and taste to have an unaffable taste.

The non-tea-based, packaged beverage is produced (1) by adding a sour seasoning to the purified product of green tea extract to adjust the pH to 2 to 6 or (2) by adding a carbohydrate.

In another purified product of green tea extract for use in the present invention, the content weight ratio of (F) quinic acid or a salt thereof, which may hereinafter be referred to collectively as “quinic acid”, to (A) non-polymer catechins [(B)/(A)] is from 0 to 0.018, preferably from 0.00005 to 0.016, more preferably from 0.00005 to 0.014, still more preferably from 0.00005 to 0.012, yet more preferably from 0.00005 to 0.01, even more preferably from 0.00005 to 0.008, still even more preferably from 0.00005 to 0.008. Upon formulation into a beverage, it is necessary for the manifestation of the advantageous effects of the present invention to control the content of quinic acid to the above-described range beforehand in the purified product of green tea extract, because quinic acid may be considered to be mixed in as a beverage ingredient other than the purified product of green tea extract. Insofar as the content weight ratio [(F)/(A)] falls within this range, a refreshing feeling is not rendered fuzzy even after storage over a long term, the persistence of a sour taste which is generally experienced when taken especially in a sport scene is not experienced, and therefore, the packaged beverage is excellent in mouth refreshment. Even in a form filled in an oxygen permeable, clear container or even in an exposure test, the packaged beverage is resistant to alterations in external appearance. The packaged beverage, therefore, has excellent color tone stability even when exposed to light under oxygen permeation. Outside the above range, the advantageous effects of the present invention cannot be brought about, and moreover, quinic acid is abundantly introduced from the catechin source into the beverage so that the beverage is unbalanced in flavor and taste to have no particular taste.

The non-tea-based, packaged beverage is produced by adding a sweetener, a sour seasoning, sodium ions and potassium ions to the purified product of green to adjust the pH to 2 to 6.

The content of non-polymer catechins in the purified product of green tea extract for use in the present invention may be preferably from 50 to 100 wt %, more preferably from 55 to 100 wt %, still more preferably from 60 to 100 wt %, still more preferably from 65 to 100 wt %, yet more preferably from 70 to 100 wt %, even more preferably from 75 to 100 wt %, still even more preferably from 80 to 100 wt %, yet still even more preferably from 81 to 100 wt %. Insofar as the content of non-polymer catechins falls within this range, the predetermined ratio of oxalic acid to the non-polymer catechins can be readily achieved in the beverage even if the purified product of green tea extract to be contained in the beverage contains catechins at high concentration. Therefore, the beverage is improved further in the flavor-taste balance, is provided with an unaffable taste, and is preferred. In the production of the non-tea-based, packaged beverage, the purified product of green tea extract and other beverage ingredients may be premixed beforehand prior to the production. It is, therefore, preferred to control the content of non-polymer catechins to the above-described range in the purified product of green tea extract. It is to be noted that the content of non-polymer catechins in the purified product of green tea extract is a content based on solid constituents.

From the viewpoint of long-term drinkability that, even when stored over a long term, neither an unpleasant taste nor an offensive smell is produced much and a deteriorated odor of a flavoring is rendered hardly perceivable, the content weight ratio of (C) caffeine to (A) non-polymer catechins [(C)/(A)] in the purified product of green tea extract may be preferably from 0 to 0.09, more preferably from 0 to 0.08, still more preferably from 0 to 0.07, still more preferably from 0 to 0.06, yet more preferably from 0 to 0.05, even more preferably from 0 to 0.04, still even more preferably from 0 to 0.03. As a method for specifically lowering the content of caffeine, it is possible to mention, for example, a method which comprises dissolving a concentrate of green tea extract in water and then conducting multistage extraction with chloroform.

When the purified product of green tea extract is one purified to such an extent that the content ratio of quinic acid to catechins is zero or close to zero, the content weight ratio of (B) oxalic acid or a salt thereof to (A) non-polymer catechins [(B)/(A)] in the purified product may be from 0 to 0.002, preferably from 0 to 0.0018, more preferably from 0 to 0.0015, still more preferably from 0 to 0.0012, yet more preferably from 0 to 0.001, even more preferably from 0 to 0.0008, still even more preferably from 0 to 0.0007 from the viewpoint of long-term drinkability that, even when stored over a long term, neither an unpleasant taste nor an offensive smell is produced much and a deteriorated odor of a flavoring is rendered hardly perceivable. As a method for specifically lowering the content of oxalic acid or the salt thereof, it is possible to mention, for example, a method which includes dissolving a concentrate of green tea extract in water and then conducting multistage extraction with an organic solvent.

The non-tea-based, packaged beverage according to the present invention may contain other ingredient or ingredients as needed in addition to the purified product of green tea extract.

The non-tea-based, packaged beverage according to the present invention contains non-polymer catechins (A), in a form dissolved in water, at a content of from 0.03 to 0.6 wt %, preferably from 0.04 to 0.6 wt %, more preferably from 0.05 to 0.6 wt %, still more preferably from 0.06 to 0.5 wt %, still more preferably from 0.07 to 0.5 wt %, yet more preferably from 0.08 to 0.5 wt %, still yet more preferably from 0.09 to 0.4 wt %, still yet more preferably from 0.1 to 0.4 wt %, even more preferably from 0.1 to 0.3 wt %, still even more preferably from 0.1 to 0.26 wt %. Insofar as the content of non-polymer catechins falls within the above-described range, the non-polymer catechins can be readily ingested, and moreover, such a content is also preferred in that the packaged beverage does not undergo much alterations in flavor and taste in its production steps.

As a purification method for lowering the content of oxalic acid, caffeine or quinic acid in a beverage, purification can be conducted by dissolving a green tea extract in water and then subjecting the resulting solution to one of activated carbon treatment, acid clay treatment and high-molecular resin treatment or to a combination of two or more of such treatments. As a purification step, the above-described purification can be conducted either after dissolving or diluting the green tea extract or after mixing all the ingredients. The former is, however, preferred because the composition of the beverage is less changed.

The percentage of the generic term “gallates”, which consist of catechin gallate, epicatechin gallate, gallocatechin gallate and epigallocatechin, based on all non-polymer catechins in the green tea extract for use in the present invention can preferably be from 35 to 100 wt % from the standpoint of the effectiveness of physiological action of the non-polymer catechins. From the standpoint of the readiness in adjusting the taste, the percentage of the gallates may be more preferably from 35 to 98 wt %, still more preferably from 35 to 95 wt %.

In the non-tea-based, packed beverage according to the present invention, the content weight ratio of (J) epi-form catechins to (A) non-polymer catechins [(J)/(A)] may be preferably from 0.7 to 1.0, more preferably from 0.72 to 1.0, still more preferably from 0.74 to 1.0, yet more preferably from 0.76 to 1.0, even more preferably from 0.76 to 0.99, still even more preferably from 0.77 to 0.98. The epi-form catechins (J) can be exemplified by epicatechins, epigallocatechins, epicatechin gallates, epigallocatechin gallates, and the like. The above-described range is preferred in that in addition to reduced alterations in flavor and taste in the course of its preparation, it is in a form permitting easy ingestion of naturally-existing catechins because its composition is extremely close to the composition of catechins contained in tea leaves in the natural world.

The content weight ratio of (B) oxalic acid or a salt thereof to (B) non-polymer catechins [(B)/(A)] in the non-tea-based, packaged beverage according to the present invention is from 0 to 0.02, preferably from 0 to 0.015, more preferably from 0 to 0.01, still more preferably from 0 to 0.008, still more preferably from 0 to 0.006, yet still more preferably from 0 to 0.004, yet still more preferably from 0 to 0.002, even more preferably from 0 to 0.0018, still even more preferably from 0 to 0.0015, yet still even more preferably from 0.00005 to 0.0015. Oxalic acid is primarily contained in plant or fruit extracts including a tea extract. It can be added either in the acid form or in a salt form. As the salt of oxalic acid, the sodium salt or potassium salt can be mentioned.

The content weight ratio of (F) quinic acid or a salt thereof to (B) non-polymer catechins [(F)/(A)] in the non-tea-based, packaged beverage according to the present invention is from 0 to 0.2, preferably from 0.00005 to 0.18, more preferably from 0.00005 to 0.15, still more preferably from 0.00005 to 0.1, still more preferably from 0.00005 to 0.08, yet still more preferably from 0.00005 to 0.04, yet still more preferably from 0.00005 to 0.02, even more preferably from 0.00005 to 0.018, still even more preferably from 0.00005 to 0.016, still even more preferably from 0.00005 to 0.014, yet still even more preferably from 0.00005 to 0.014. Quinic acid is primarily contained in plant or fruit extracts including a tea extract. It can be added either in the acid form or in a salt form. As the salt of quinic acid, the sodium salt or potassium salt can be mentioned.

As the ratio of oxalic acid or quinic acid to the non-polymer catechins falls within this range, the catechins and oxalic acid or quinic acid are prevented from forming weakly-associated units through hydrogen bonds or the like and hence, from being adsorbed on gustatory bud cells. The catechins are, therefore, not controlled in their contact to the bitterness receptors so that the inherent taste quality of the catechins is not altered.

By limiting the content weight ratios [(B)/(A)] and [(F)/(A)] of these ingredients to the above-described ranges, a refreshing feeling is not rendered fuzzy even after storage over a long term, the persistence of a sour taste which is generally experienced when taken especially in a sport scene is not experienced, and therefore, the packaged beverage is excellent in mouth refreshment. Even in a form filled in an oxygen permeable, clear container or even in an exposure test, the packaged beverage is resistant to alterations in external appearance. The packaged beverage, therefore, has excellent color tone stability even when exposed to light under oxygen permeation.

From the viewpoint of long-term drinkability that, even when stored over a long term, neither an unpleasant taste nor an offensive smell is produced much and a deteriorated odor of a flavoring is rendered hardly perceivable, the content weight ratio of (C) caffeine to (A) non-polymer catechins [(C)/(A) in the non-tea-based, packaged beverage according to the present invention may be preferably from 0 to 0.09, more preferably from 0 to 0.08, still more preferably from 0 to 0.07, still more preferably from 0 to 0.06, yet more preferably from 0 to 0.05, even more preferably from 0 to 0.04, still even more preferably from 0 to 0.03.

By limiting the content weight ratios [(B)/(A)] and [(C)/(A)] of these ingredients to the above-described ranges, a refreshing feeling is not rendered fuzzy even after storage over a long term, the persistence of a sour taste which is generally experienced when taken especially in a sport scene is not experienced, and a disagreeable aftertaste which is generally experienced from the middle of taking a beverage especially in a sport scene hardly remains, and therefore, the packaged beverage is excellent in mouth refreshment. Even in a form filled in an oxygen permeable, clear container or even when exposed to lighting over a long term in a shop window, the packaged beverage is resistant to alterations in external appearance. The packaged beverage, therefore, has excellent color tone stability even when exposed to light under oxygen permeation.

The content of the sour seasoning (D), when contained, in the non-tea-based, packaged beverage according to the present invention is from 0.03 to 1.0 wt %, preferably from 0.05 to 1.0 wt %, more preferably from 0.1 to 1.0 wt %, still more preferably from 0.12 to 1.0 wt %, even more preferably from 0.15 to 0.9 wt %. The sour seasoning (D) is used not only to impart a sour taste to the non-tea-based, packaged beverage but also to maintain its pH at 2 to 6. As the sour seasoning (D), an edible organic acid or inorganic acid or a salt thereof can be mentioned. These acids can be used either in their undissociated forms or as their salts such as their sodium salt and potassium salt. Preferred acids include citric acid, malic acid, fumaric acid, adipic acid, gluconic acid, tartaric acid, acetic acid, phosphoric acid, and mixtures thereof, with citric acid and malic acid being more preferred. These sour seasonings are also effective as an antioxidant which stabilizes the beverage ingredients. It is to be noted that the term “sour seasoning (D)” as used herein does not include any one of ascorbic acid, oxalic acid and salts thereof.

In the non-tea-based, packaged beverage according to the present invention, the carbohydrate (E) may be incorporated to lessen the bitterness and astringency of the non-polymer catechins. The content of the carbohydrate is from 0.001 to 15 wt % in terms of equivalent fructose amount and from 0 to 0.05 wt % in terms of equivalent glucose amount, preferably from 0.001 to 13 wt % in terms of equivalent fructose amount and from 0 to 0.05 wt % in terms of equivalent glucose amount, still more preferably from 0.001 to 10 wt % in terms of equivalent fructose amount and from 0 to 0.05 wt % in terms of equivalent glucose amount. The terms “equivalent fructose amount” and “equivalent glucose amount” as used herein mean an amount of fructose and an amount of glucose as determined by HPLC or post-hydrolysis HPLC. Where the ratio of fructose to glucose is fixed as in sucrose, the measurement of a sucrose content makes it possible to easily calculate the amounts of fructose and glucose. Insofar as the equivalent fructose amount and equivalent glucose amount fall within these ranges, no strong bitterness, astringency or puckeriness is produced and bitterness and astringency are lessened, so that the packaged beverage is suited for long-term drinking and is excellent in the stability of bitterness and astringency and also in the feeling as it passes down the throat. In particular, an equivalent glucose amount of 0.05 wt % or higher in a beverage with non-polymer catechins added therein may become a cause of turbidity during its storage, and therefore, is not preferred.

As the carbohydrate, a soluble carbohydrate is preferred. The carbohydrate plays a role not only as sweetener but also as an energy source. As a standard upon selecting a carbohydrate, it is important to take into consideration a sufficient gastric emptying rate and intestinal absorption rate. The carbohydrate can be a mixture of glucose and fructose, or a carbohydrate hydrolyzable into glucose and fructose or capable of forming glucose and fructose in the digestive tract. Examples of the carbohydrate for use in the present invention include monosaccharides, oligosaccharides, conjugated polysaccharides, and mixtures thereof. Monosaccharides include tetroses, pentoses, hexoses, and ketohexoses. Examples of hexoses are aldohexoses such as glucose known as grape sugar. The amount of glucose contained in the non-tea-based, packaged beverage according to the present invention is from 0 to 0.05 wt %, preferably from 0 to 0.04 wt %, more preferably from 0 to about 0.035 wt %. Fructose which is also known as “fruit sugar” is a ketohexose. The amount of fructose contained in the non-tea-based, packaged beverage according to the present invention is from 0.001 to 15 wt %, preferably from 0.001 to 13 wt %, more preferably from 0.001 to 10 wt %.

The non-tea-based, packaged beverage according to the present invention may contain glucose, fructose and/or a carbohyd rate which forms these sugars in the body (i.e., sucrose, maltodextrin, corn syrup, or fructose-rich corn syrup). Among oligosaccharides, an illustrative disaccharide is sucrose which is also known as “cane sugar” or “beet sugar”. Sucrose can be added such that the amount of sucrose in the non-tea-based, packaged beverage according to the present invention gives an equivalent fructose amount of from 0.001 to 15 wt % and an equivalent glucose amount of from 0 to less than 0.05 wt %.

As the sweetener (I) in the non-tea-based, packaged beverage according to the present invention, it is preferred to use the above-described carbohydrate sweetener where the target non-tea-based, packaged beverage is also intended to replenish energy. Where no positive energy replenishment is intended, on the other hand, it is preferred to use an artificial sweetener.

Examples of the artificial sweetener include high-sweetness sweeteners such as aspartame, saccharin, cyclamate, acesulfame-K, L-aspartyl-L-phenylalanine lower alkyl ester sweetener, L-aspartyl-D-alanine amide, L-aspartyl-D-serine amide, L-aspartyl-hydroxymethylalkanamide sweetener, L-aspartyl-1-hydroxyethylalkanamide sweetener, sucralose and thaumatin, sugar alcohols such as erythritol, xylitol and trehalose, glycyrrhizin, and synthetic alkoxyaromatic compounds. Stevioside and other natural-source sweeteners are also usable. When an artificial sweetener is used, its content can be from 0.0001 to 20 wt %.

As a carbohydrate-based sweetener, a soluble carbohydrate is used. A soluble carbohydrate has roles as a sweetener and also, as an energy source. Upon selecting a carbohydrate to be used in the beverage, it is important as a selection standard to assure a sufficient gastric emptying rate and intestinal absorption rate. The soluble carbohydrate can be a mixture of glucose and fructose, or a carbohydrate hydrolyzable into glucose and fructose or capable of forming glucose and fructose in the digestive tract. The term “carbohydrate” as used herein includes monosaccharides, oligosaccharides, conjugated polysaccharides, and mixtures thereof.

Monosaccharide include tetroses, pentoses, hexoses and ketohexoses. Examples of the hexoses are aldohexoses such as glucose known as grape sugar. When glucose is used, its content may be preferably from 0.0001 to 20 wt %, more preferably from 0.001 to 15 wt %, still more preferably from 0.001 to 10 wt %, even more preferably from 0.001 to 8 wt %. Fructose known as “fruit sugar” is a ketohexose. When fructose is used, its content is preferably from 0.0001 to 20 wt %, more preferably from 0.001 to 15 wt %, still more preferably from 0.001 to 10 wt %, even more preferably from 0.001 to 8 wt %.

Examples of the oligosaccharides include carbohydrates capable of forming these two types of monosaccharides in the body (i.e., sucrose, maltodextrin, corn syrup, and fructose-rich corn syrup). Among these oligosaccharides, those of an important type are disaccharides. An illustrative disaccharide is sucrose known as cane sugar or beet sugar. When sucrose is used, its content may be preferably from 0.001 to 20 wt %, more preferably from 0.001 to 15 wt %, even still more preferably from 0.001 to 10 wt %, even more preferably from 0.001 to 8 wt %.

Preferred examples of the conjugated polysaccharides are maltodextrins. A maltodextrin is a conjugated polysaccharide the length of which is composed of several glucose units. They are spray-dried conjugated polysaccharides obtained by the hydrolysis of corn starch. The dextrose equivalent of a maltodextrin is an index of a degree of hydrolysis of a starch polymer.

The carbohydrate sweetener can be composed preferably of a combination of fructose and glucose which serve as an energy source capable of supplying a necessary calorie. As sucrose is completely hydrolyzed into fructose and glucose in the digestive tract, sucrose can be used as a fructose and glucose supply source. These saccharides are energy foods which can be completely used by body cells.

As a glycerol, glycerol can be mentioned. When glycerol is used, its content can be preferably from 0.1 to 1.5 wt %, more preferably from 0.1 to 10 wt %.

In the non-tea-based, packaged beverage according to the present invention, it is preferred to control the total carbohydrate content to 0.0001 to 20 wt % based on the whole weight. The total carbohydrate content includes, in addition to one used as a sweetener, those naturally contained in a fruit juice or tea extract and one or more carbohydrates added. Carbohydrate derivatives, polyhydric alcohols other than glycerols, and the like may be used such that they can be readily absorbed and distributed throughout the body to supply energy.

The non-tea-based, packaged beverage according to the present invention may contain sodium ions (G) and potassium ions (H). With the packaged beverage with these ions added therein, a refreshing feeling is not rendered fuzzy even after storage over a long term, the persistence of a sour taste which is generally experienced when taken especially in a sport scene is not experienced, and therefore, the packaged beverage with these ions added therein is excellent in mouth refreshment. It is, accordingly, suited as a gulp beverage especially in the scene of a sport, to say nothing of taking it in everyday life.

The non-tea-based, packaged beverage according to the present invention may preferably contain from 0.0001 to 0.2 wt % of sodium ions (G) and from 0.0001 to 0.1 wt % of potassium ions (H). Within these ranges, the packaged beverage is sufficient in taste even when taken in various situations, permits an effective replenishment of minerals, does not have a strong taste of salts themselves, and therefore, is preferred for taking over a long term.

Sources for sodium ions (G) include readily available sodium salts such as sodium chloride, sodium carbonate, sodium hydrogencarbonate, sodium citrate, sodium phosphate, sodium hydrogenphosphate, sodium tartrate, sodium benzoate and mixtures thereof, and those derived from plant or fruit extracts or tea ingredients. A lower sodium ion concentration is more desired in facilitating the absorption of water under osmotic pressure, but preferably, the sodium ion concentration can be of such a level that no water is sucked from the body into the intestine under osmotic pressure. A sodium ion concentration needed to meet this preferred requirement is preferably lower than the plasma sodium ion concentration. The content of sodium ions (G) in the non-tea-based, packaged beverage according to the present invention is preferably from 0.0001 to 0.2 wt %, more preferably from 0.0005 to 0.2 wt %, still more preferably from 0.001 to 0.15 wt %, yet more preferably from 0.002 to 0.15 wt %, even more preferably from 0.003 to 0.1 wt %, still even more preferably from 0.0035 to 0.09 wt %.

Sources for potassium ions (H) include potassium salts such as potassium chloride, potassium carbonate, potassium sulfate, potassium acetate, potassium hydrogen carbonate, potassium citrate, potassium phosphate, potassium hydrogen phosphate, potassium tartrate, potassium sorbate and mixtures thereof, and those derived from plant or fruit extracts or tea ingredients. The content of potassium ions (H) in the packaged beverage according to the present invention is preferably from 0.0001 to 0.1 wt %, more preferably from 0.0005 to 0.1 wt %, still more preferably from 0.001 to 0.08 wt %, yet more preferably from 0.002 to 0.08 wt %, even more preferably from 0.003 to 0.08 wt %, still even more preferably from 0.0035 to 0.07 wt %.

In addition to sodium ions (G) and potassium ions (H), the non-tea-based, packaged beverage according to the present invention may contain from 0.0001 to 0.3 wt %, preferably from 0.0002 to 0.3 wt %, more preferably from 0.0005 to 0.3 wt % of chloride ions. This chloride ion ingredient can be added in the form of a salt such as sodium chloride or potassium chloride. The non-tea-based, packaged beverage according to the present invention may further contain other trace ions such as calcium, magnesium, zinc and iron ions. These ions may also be added in the form of salts. The total level of existing ions includes, in addition to the amounts of added ions, the amounts of ions naturally existing in the beverage. When sodium chloride is added, for example, its corresponding amount of sodium ions and its corresponding amount of chloride ions should also be included in the total amount of individual ions accordingly.

In the non-tea-based, packaged beverage according to the present invention, one or more flavorings selected from plants and/or fruits may be contained to further improve the taste. Flavorings are generally called “flavors” or “fruit juices”. Natural or synthetic flavorings can be used.

As flavors, fruit flavors, plant flavors, tea flavors and mixtures thereof can be used. In particular, combinations of fruit flavors and tea flavors, preferably green tea flavor or black tea flavor have preferred tastes.

Preferred flavors are citrus flavors including orange flavor, lemon flavor, lime flavor and grape fruit flavor. As other fruit flavors, apple flavor, grape flavor, raspberry flavor, cranberry flavor, cherry flavor, pineapple flavor and the like can be used. Further, as natural flavors, jasmine, chamomile, rose, peppermint, Crataegus cuneata, chrysanthemum, water caltrop, sugar cane, bracket fungus of the genus Formes (Formes japonicus), bamboo shoot, and the like can be mentioned. These flavors can be natural flavors like fruit flavors and balms or synthetic flavors. The term “flavoring” as used herein can also include blends of various flavors, for example, a blend of lemon and lime flavorings and blends of citrus flavorings and selected spices (typically, flavorings for cola and other soft drinks) As flavors consisting of hydrophobic concentrates or extracts, synthetic flavor esters, alcohols, aldehydes, terpenes, sesquiterpenes and the like can be added.

Preferred fruit juices include juices of apple, pear, lemon, lime, mandarin, grapefruit, cranberry, orange, strawberry, grape, kiwi, peach, pineapple, passion fruit, mango, Japanese apricot, guava, raspberry, cherry juices and the like. More preferred are citrus juices, grapefruit, orange, lemon, lime and mandarin juices, mango juice, passion fruit juice and guava juice, and mixtures thereof.

When a flavor is used as a flavoring, it is preferred to contain the flavor at from 0.0001 to 5 wt %, preferably from 0.0001 to 3 wt %, more preferably from 0.0001 to 1 wt %, still more preferably from 0.001 to 1 wt %, yet more preferably from 0.001 to 0.5 wt %, even more preferably from 0.001 to 0.2 wt %, still even more preferably from 0.003 to 0.18 wt % in the non-tea-based, packaged beverage according to the present invention.

When a fruit juice is used as a flavoring, it is preferred to contain the fruit juice at from 0.001 to 15 wt %, preferably from 0.002 to 10 wt % in the non-tea-based, packaged beverage according to the present invention.

Where oxalic acid is contained in such a flavoring, however, it is preferred to use a flavoring of low oxalic acid content because the content of the flavoring is determined in relation to the content of oxalic acid.

A flavor in a flavoring may be formed into emulsified small droplets, and may then be dispersed in the beverage. In other words, it can be formed into an emulsified flavor. These emulsified small droplets generally has a specific gravity lower than water, and tends to form a separated phase. To keep the emulsified small droplets dispersed in the beverage, it is preferred to contain a specific gravity regulator (which can also act as an opacifier). Examples of such a specific gravity regulator include brominated vegetable oils (BVO) and resin esters, preferably ester gums. About the use of specific gravity regulators or opacifiers in liquid beverages, a description is found in L. F. Green, Developments in Soft Drinks Technology, Vol. 1, 87-93, Applied Science Publishers Ltd. (1978). Typically, emulsified flavors are readily available as concentrates or extracts or in the form of synthetic flavoresters, alcohols, aldehydes, terpenes, sesquiterpenes or the like. Typically, such a flavor can be contained at from 0.0001 to 5 wt %, preferably from 0.001 to 3 wt % in the beverage according to the present invention. Representative examples include “Superemulsion Flavor Series”, “Grape Fruit 106JX”, “Lemon 106JX”, “Orange 106JX” and the like (trade names; product of Taiyo Kagaku Co., Ltd.).

The inclusion of a bitterness/astringency suppressor in the non-tea-based, packaged beverage according to the present invention is preferred because the beverage becomes still easier to take. As a bitterness/astringency suppressor to be used, a cyclodextrin is preferred. Usable examples of the cyclodextrin include α-, β- and γ-cyclodextrins and branched α-, β- and γ-cyclodextrins. In the beverage, the cyclodextrin can be contained at from 0.005 to 0.5 wt %, preferably from 0.01 to 0.3 wt %.

In the non-tea-based, packaged beverage according to the present invention, one or more vitamins can be incorporated further. Preferred vitamins include vitamin A, vitamin C, and vitamin E. Other vitamins such as vitamin D and vitamin B may also be used. One or more minerals can also be used. Preferred minerals include calcium, chromium, copper, fluorine, iodine, iron, magnesium, manganese, phosphorus, selenium, silicon, molybdenum, and zinc. More preferred minerals are magnesium, phosphorus, and iron.

To the non-tea-based, packaged beverage according to the present invention, it is also possible to add either singly or in combination ingredients other than the above-described ingredients, such as various esters, colorants, emulsifiers, preservatives, seasoning agents, gums, oils, amino acids, vegetable extracts, flower honey extracts, pH regulators, quality stabilizers, and carbon dioxide.

Although the pH of the non-tea-based, packaged beverage according to the present invention is from 2 to 6, it is preferably from 2.8 to 6, more preferably from 3 to 6, still more preferably from 3.0 to 5.5, even more preferably from 3.1 to 5.5, still even more preferably from 3.2 to 5.5. An excessively low pH provides the beverage with a strong sour taste and pungent smell, and moreover, makes it impossible to gulp the beverage down as a thirst-relieving beverage in a situation where water is desired especially as in a sport, to say nothing of taking it in everyday life. The beverage is inferior in taste, and in addition, is somewhat inferior in the stability of bitterness, astringency and non-polymer catechins when stored over a long term and has some tendency of producing an unpleasant taste and offensive smell. Such an excessively low pH is hence not preferred. An excessively high pH, on the other hand, makes it impossible to harmonize the flavor and taste so that a reduction in taste is experienced when the beverage is taken in everyday life or while playing sports. Such an excessively high pH is thus not preferred either.

The turbidity (haze value) of the packaged beverage according to the present invention can range preferably from 0.1 to 80, more preferably from 0.15 to 80, still more preferably from 0.5 to 80, even more preferably from 1 to 75, still even more preferably from 1 to 70. It is to be noted that the haze value ranges from 1 to 100 and is 0 for water. When the haze value of the packaged beverage falls within the above-described range, it is indicated that the ingredients are contained in an evenly dispersed state. Even when stored over a long term, neither the production of an unpleasant taste and offensive smell due to undissolved ingredients nor a deteriorated smell of a flavoring is perceivable so that the packaged beverage is suited for long-term drinking. Further, even in a form filled in an oxygen permeable, clear container, the beverage is not altered in external appearance even when exposed to lighting in a shop window. The beverage is, therefore, excellent in color tone stability even when exposed to light under oxygen permeation.

Non-tea-based, packaged beverages include, for example, carbonated beverages as soft drinks, beverages with fruit extracts, juices with vegetable extracts, near waters, sport drinks, isotonic drinks, diet drinks, and the like. A sport drink or isotonic drink is generally defined to be a beverage which can promptly replenish water and minerals lost as sweat during physical exercises. However, carbonated beverages are too strong in sour taste and pungency, and as thirst-relieving beverages to be taken when water is desired especially while playing sports, are painful to the throat, cannot be gulped down, and are inferior in taste. When stored over a long term, the stability of bitterness, astringency and non-polymer catechins are somewhat deteriorated to have some tendency of producing an unpleasant taste and offensive smell. It is, therefore, desired to avoid carbonate beverages.

Similar to general beverages, an ordinary container such as a molded package made of polyethylene terephthalate as a principal component (a so-called PET bottle), a metal can, a paper container combined with metal foils or plastic films or a bottle can be used as a package for producing the non-tea-based, packaged beverage according to the present invention.

The non-tea-based, packaged beverage according to the present invention can preferably be in a form filled in an oxygen-permeable, clear container. A colored, oxygen-permeable container is also usable provided that it is a clear container. Even in a form filled in an oxygen-permeable, clear container, the beverage is hardly altered in external appearance even when exposed to lighting over a long term. The beverage, therefore, is excellent in color tone stability when exposed to light under oxygen permeation, thereby developing an advantageous effect of the present invention.

When the purified product of green tea extract to be used has been purified to such an extent that oxalic acid is removed to zero or close to zero relative to catechins, the oxygen permeability factor of the container is from 0.0001 to 0.5 mL/350 mL·day·atm, preferably from 0.001 to 0.45 mL/350 mL·day·atm per bottle.

When the purified product of green tea extract to be used has been purified to such an extent that quinic acid is removed to zero or close to zero relative to catechins, the oxygen permeability factor (at room temperature) of the container is from 0 to 0.1 mL/350 mL·day·atm, preferably from 0.0001 to 0.09 mL/350 mL·day·atm, more preferably from 0.0001 to 0.07 mL/350 mL·day·atm, still more preferably from 0.0001 to 0.05 mL/350 mL·day·atm.

The non-tea-based, packaged beverage according to the present invention can be produced, for example, by filling the beverage in a container such as a metal can and, when heat sterilization is feasible, conducting heat sterilization under sterilization conditions as prescribed in the Food Sanitation Act. For those which cannot be subjected to retort sterilization like PET bottles or paper containers, a process is adopted such that the beverage is sterilized beforehand under similar sterilization conditions as those described above, for example, is sterilized at a high temperature for a short time by a plate-type heat exchanger, is cooled to a prescribed temperature, and is then filled in a container. Under aseptic conditions, additional ingredients may be added to and filled in a beverage-filled container. It is also possible to conduct an operation such that subsequent to heat sterilization under acidic conditions, the pH of the beverage is caused to arise back to neutral under aseptic conditions or that subsequent to heat sterilization under neutral conditions, the pH of the tea beverage is caused to drop back to the acidic side under aseptic conditions.

### EXAMPLES

Measurement methods employed in examples will hereinafter be described. However, the present invention is not limited to the following methods and measurement conditions, and instead, other methods and conditions capable of enabling high-sensitivity and high-accuracy detections can be used without any problems provided that they permit precise measurements. Further, pretreatment (for example, lyophilization, or the removal of an ingredient which may interfere with a measurement) may be applied as needed.

Measurement of Catechins

A high-performance liquid chromatograph (model: “SCL-10AVP”, trade name) manufactured by Shimadzu Corporation was used. The chromatograph was fitted with an LC column packed with octadecyl-introduced silica gel, “L-Column, TM ODS” (trade name; 4.6 mm in diameter×250 mm in length; product of Chemicals Evaluation and Research Institute, Japan) A packaged beverage, which had been filtered through a filter (0.8 μm) and then diluted with distilled water, was subjected to chromatography at a column temperature of 35° C. by gradient elution. A 0.1 mol/L solution of acetic acid in distilled water and a 0.1 mol/L solution of acetic acid in acetonitrile were used as mobile phase solution A and mobile phase solution B, respectively. The measurement was conducted under the conditions of 20 μL injected sample quantity and 280 nm UV detector wavelength.

Measurement of Caffeine

Measured using the measurement method for catechins.

Measurement of Oxalic Acid or its Salt

An ion chromatograph (manufactured by Japan Dionex Co., Ltd.) was fitted with a column, “IonPac AS4A-SC” (trade name, 4 mm in diameter×250 mm in length) and was connected to a suppressor, “ASRS-ULTRA” (tradename; manufactured by Dionex Corporation). Measurement of oxalic acid or its salt was performed in the recycle mode. As mobile phases, 1.8 mmol/L Na₂CO₃ and 1.7 mmol/L NaHCO₃ were fed at 1.0 mL/min. The injected sample quantity was set at 25 μL. An electrical conductivity detector was used as a detector.

Measurement of Organic Acids or Their Salts (Other than Oxalic Acid or its Salt)

The analytical quantitation method described in Revised Food Analysis Handbook, 7. Analytical Quantitation of Organic Acids, 367-379, K. K. Kenpakusha (Revised edition, 4^{th} print published: Sep. 1, 1991) (written in Japanese) was followed.

Concerning quinic acid, for example, the Japan Food Research Laboratories method which relies upon HPLC was followed. Each sample (2 g) was filtered subsequent to ultrasonication, and was then measured by high-performance liquid chromatography.
Model: “LC-10AD” (trade name, Shimadzu Corporation)
Detector: UV-visible spectrophotometer, “SPD-6AV” (tradename, Shimadzu Corporation)
Column: “TSKGEL OApak” (trade name, 7.8 mm in diameter×300 mm in length, TOSOH CORPORATION)
Column temperature: 40° C.
Mobile phase: 0.75 mmol/L sulfuric acid
Reaction solution: 15 mmol/L solution of disodium hydrogenphosphate, which contained 0.2 mmol/L bromothymol blue.
Measurement wavelength: 445 nm
Flow rates: Mobile phase—0.8 mL/min
   Reaction solution—0.8 mL/min
      Conversion Method of Carbohydrate into Fructose and Glucose, and Measurements

Free fructose, glucose and sucrose were measured by the below-described method (a), and post-hydrolysis fructose and glucose were measured by the below-described method (b) From those measurement values, an equivalent glucose amount and equivalent fructose amount were determined.

(a) The Japan Food Research Laboratories Method Relying Upon HPLC (Free Fructose, Glucose and Sucrose)

Each sample was collected, to which water was added, followed by neutralization to remove interfering substances. The thus-prepared solution was filtered through a membrane filter (pore diameter: 0.45 μm) to provide a test solution. The test solution was measured by HPLC under the following conditions.

<Conditions for High-Performance Liquid Chromatography>

Model: “LC-10ADvp” (trade name, Shimadzu Corporation)
Detector: Differential refractometer, “RID-10A” (trade name, Shimadzu Corporation)
Column: “Wakosil 5NH₂” (trade name, 4.6 mm in diameter×250 mm in length, Wako Pure Chemical Industries, Ltd.)
   (b) The Japan Food Research Laboratories Method Relying Upon HPLC (Fructose and Glucose After Their Hydrolyses)

Each sample was collected, hydrolyzed with hydrochloric acid, cooled, filtered (No. 5B), and then filtered through a membrane filter (pore diameter: 0.45 μm) to provide a test solution. The test solution was measured by HPLC under the following conditions.

<Conditions for High-Performance Liquid Chromatography>

Model: “LC-10ADvp” (trade name, Shimadzu Corporation)
Detector: Spectrofluorometer, “RF-10AXL” (tradename, Shimadzu Corporation)
Column: “TSKgel SUGAR AXI” (trade name, 4.6 mm in diameter×150 mm in length, TOSOH CORPORATION)

A carbohydrate is composed of glucose and/or fructose substantially in its entirety. To analyze a carbohydrate the constituent sugars of which are already known along with their ratio (for example, sucrose is composed of glucose and fructose), it is only necessary to measure the content of the carbohydrate directly by HPLC and then to conduct calculations on the basis of the content (sucrose is composed of glucose and fructose at 1:1, and therefore, ½ fractions of the content of sucrose are an equivalent fructose amount and an equivalent glucose amount, respectively).

In the case of a carbohydrate the constituent sugars of which and their ratios are not known beforehand (for example, dextrin), the amounts of fructose and glucose are measured by HPLC subsequent to hydrolysis. As a carbohydrate is composed of glucose and/or fructose substantially in its entirety, its equivalent fructose amount and equivalent glucose amount can be directly measured by this method.

Measurement of Sodium Ions

Atomic Fluorescence Spectroscopy (Extraction with Hydrochloric Acid)

Each sample (5 g) was placed in 10% hydrochloric acid (to provide a 1% HCl solution when dissolved to a predetermined volume). With deionized water, the resulting solution was then brought to the predetermined volume, and its absorbance was measured.

Wavelength: 589.6 nm

Flame: acetylene-air

Quantitation of Potassium Ions

Atomic Fluorescence Spectroscopy (Extraction with Hydrochloric Acid)

Each sample (5 g) was placed in 0.10% hydrochloric acid (to provide a 1% HCl solution when dissolved to a predetermined volume). With deionized water, the resulting solution was then brought to the predetermined volume, and its absorbance was measured.

### Examples 1-5 & Comparative Examples 1-3

The packaged beverage of each example or comparative example was produced by mixing the corresponding ingredients shown in Table 1 or Table 2 and then conducting predetermined post-treatment.

TABLE 1

| | | Examples | | |
|---|---|---|---|---|
| | | 1 | 2 | 3 |
| Purified product (A) of green tea extract (*1) | | — | — | 0.13 |
| Concentrate (B) of green tea extract (*2) | | — | — | — |
| Purified product (C) of green tea extract (*3) | | 0.08 | 0.68 | 0.2 |
| Purified product (D) of green tea extract (*4) | | — | — | — |
| Purified product (E) of green tea extract (*5) | | — | — | — |
| Oxalic acid | | — | — | — |
| Ascorbic acid | | 0.03 | 0.03 | 0.03 |
| Sour seasoning | | 0.3 | 0.3 | 0.3 |
| Fructose-glucose liquid sugar | | — | — | — |
| Honey | | — | — | — |
| Fructose | | — | — | — |
| Glucose | | — | — | — |
| Stevia | | — | — | — |
| Artificial sweetener | | 5.0 | 15.0 | 5.0 |
| Minerals | | 0.07 | 0.07 | 0.07 |
| Cyclic oligosaccharide | | — | — | — |
| Fruit juice | | — | — | 0.1 |
| Flavoring | | 0.10 | 0.10 | 0.10 |
| Vitamins A, B, E | | — | — | — |
| Deionized water | | Balance | Balance | Balance |
| Total amount | | 100 | 100 | 100 |
| PH of Beverage | | 3.5 | 3.5 | 3.5 |
| Non-polymer catechins (wt %) | | 0.065 | 0.55 | 0.19 |
| Caffeine/non-polymer catechins ratio | | 0.00001 | 0.00001 | 0.008 |
| Oxalic acid/non-polymer catechins ratio | | 0.00001 | 0.00001 | 0.0015 |
| Preparation | Oxalic acid/non-polymer catechins | 0.00001 | 0.00001 | 0.0014 |
| | ratio | | | |
| | Na amount in beverage (mg/100 mL) | 47 | 47 | 47 |
| | K amount in beverage (mg/100 mL) | 6 | 6 | 6 |

| | | | |
|---|---|---|---|
| Percentage of epi-form catechins | 0.90 | 0.90 | 0.90 |
| Haze value of beverage | 55 | 50 | 54 |
| Sour taste after long-term storage | A | A | A |
| Pungency of sour taste to the throat when taken | A | A | A |
| while playing a sport | | | |
| Mouth refreshment when taken while playing a | A | A | A |
| sport | | | |
| Color tone stability when exposed to light under | A | A | A |
| oxygen permeation | | | |

Examples

| | | 4 | 5 |
|---|---|---|---|
| Purified product (A) of green tea extract (*1) | | — | — |
| Concentrate (B) of green tea extract (*2) | | — | — |
| Purified product (C) of green tea extract (*3) | | — | 0.16 |
| Purified product (D) of green tea extract (*4) | | — | — |
| Purified product (E) of green tea extract (*5) | | 0.12 | — |
| Oxalic acid | | — | — |
| Ascorbic acid | | 0.03 | 0.03 |
| Sour seasoning | | 0.15 | 0.5 |
| Fructose-glucose liquid sugar | | — | — |
| Honey | | — | — |
| Fructose | | — | — |
| Glucose | | — | — |
| Stevia | | — | — |
| Artificial sweetener | | 5.0 | 5.0 |
| Minerals | | 0.07 | 0.07 |
| Cyclic oligosaccharide | | — | — |
| Fruit juice | | — | — |
| Flavoring | | 0.10 | 0.10 |
| Vitamins A, B, E | | — | — |
| Deionized water | | Balance | Balance |
| Total amount | | 100 | 100 |
| PH of Beverage | | 3.7 | 3.4 |
| Non-polymer catechins (wt %) | | 0.12 | 0.13 |
| Caffeine/non-polymer catechins ratio | | 0 | 0.00001 |
| Oxalic acid/non-polymer catechins ratio | | 0 | 0.00001 |
| Preparation | Oxalic acid/non-polymer catechins | 0 | 0.00001 |
| | ratio | | |
| | Na amount in beverage (mg/100 mL) | 47 | 47 |
| | K amount in beverage (mg/100 mL) | 6 | 6 |

| | | |
|---|---|---|
| Percentage of epi-form catechins | 1.0 | 0.90 |
| Haze value of beverage | 53 | 55 |
| Sour taste after long-term storage | A | A |
| Pungency of sour taste to the throat when taken | A | A |
| while playing a sport | | |
| Mouth refreshment when taken while playing a | A | A |
| sport | | |
| Color tone stability when exposed to light under | A | A |
| oxygen permeation | | |

TABLE 2

| | | Comparative Examples | | |
|---|---|---|---|---|
| | | 1 | 2 | 3 |
| Purified product (A) of green tea extract (*1) | | — | 1.00 | — |
| Concentrate (B) of green tea extract (*2) | | — | — | 0.08 |
| Purified product (C) of green tea extract (*3) | | — | — | 0.20 |
| Purified product (D) of green tea extract (*4) | | 0.03 | — | — |
| Oxalic acid | | — | — | — |
| Ascorbic acid | | 0.06 | 0.03 | 0.03 |
| Sour seasoning | | 0.05 | 0.3 | 0.3 |
| Fructose-glucose liquid sugar | | 6.0 | — | — |
| Honey | | — | — | — |
| Fructose | | — | — | — |
| Glucose | | — | — | — |
| Stevia | | — | — | — |
| Artificial sweetener | | — | 5.00 | 5.0 |
| Minerals | | 0.10 | 0.07 | 0.07 |
| Cyclic oligosaccharide | | 0.2 | — | — |
| Fruit juice | | 0.06 | — | — |
| Flavoring | | 0.10 | 0.10 | 0.10 |
| Vitamins A, B, E | | 0.2 | — | — |
| Deionized water | | Balance | Balance | Balance |
| Total amount | | 100 | 100 | 100 |
| PH of Beverage | | 3.5 | 3.5 | 3.5 |
| Non-polymer catechins (wt %) | | 0.02 | 0.22 | 0.19 |
| Caffeine/non-polymer catechins ratio | | 0.003 | 0.05 | 0.024 |
| Oxalic acid/non-polymer catechins ratio | | 0.00001 | 0.01 | 0.009 |
| Preparation | Oxalic acid/non-polymer catechins | 0.00001 | 0.01 | 0.009 |
| | ratio | | | |
| | Na amount in beverage (mg/100 mL) | 32 | 47 | 47 |
| | K amount in beverage (mg/100 mL) | 21 | 44 | 20 |

| | | | |
|---|---|---|---|
| Percentage of epi-form catechins | 0.90 | 0.89 | 0.87 |
| Haze value of beverage | 60 | 0.02 | 0.02 |
| Sour taste after long-term storage | D | C | C |
| Pungency of sour taste to the throat when taken | D | D | C |
| while playing a sport | | | |
| Mouth refreshment when taken while playing a | D | D | C |
| sport | | | |
| Color tone stability when exposed to light under | C | D | D |
| oxygen permeation | | | |

(*1) Purified Product A of Green Tea Extract

“POLYPHENON™ HG” (100 g, product of Tokyo Food Techno Co., Ltd.) was suspended as a concentrate of green tea extract in a 95% aqueous solution of ethanol (490.9 g) under stirring at room temperature and 250 rpm. After activated carbon “KURARAY COAL™ GLC” (20 g, product of Kuraray Chemical K.K.) and acid clay “MIZKA ACE™ #600” (35 g, product of Mizusawa Chemical Industries, Ltd.) were poured, the resulting mixture was continuously stirred for about 10 minutes. Subsequent to the dropwise addition of a 40% aqueous solution of ethanol (409.1 g) over 10 minutes, stirring was continued for about 30 minutes still at room temperature. After the activated carbon and a precipitate were filtered off by No. 2 filter paper, the filtrate was filtered again through a 0.2 μm membrane filter. Finally, deionized water (200 g) was added to the filtrate, ethanol was distilled off at 40° C. and 0.0272 kg/cm² to obtain the product.

After the treatment, the content of non-polymer catechins was 22 wt %.

The weight ratio of oxalic acid to non-polymer catechins after the treatment=0.01

(*2) Concentrate B of Green Tea Extract

A concentrate B of green tea extract. Content of non-polymer catechins: 33.70 wt %. Percentage of gallates: 50.7 wt %. Weight ratio of oxalic acid to non-polymer catechins: 0.06.

(*3) Purified Product C of Green Tea Extract

A purified product C of green tea extract. Content of non-polymer catechins: 81.4 wt %. Percentage of gallates: 65 wt %. Weight ratio of oxalic acid to non-polymer catechins: 0.00001.

(*4) Purified Product D of Green Tea Extract

A purified product D of green tea extract. Content of non-polymer catechins: 77.0 wt %. Percentage of gallates: 99 wt %. Weight ratio of oxalic acid to non-polymer catechins: 0.00001.

(*5) Purified Product E of Green Tea Extract

Reagents of epicatechins, epigallocatechins, epicatechingallates and epigallocatechin gallates (products of Kurita Water Industries, Ltd.) were mixed into the purified product E. Content of non-polymer catechins: 99.0 wt %. Percentage of gallates: 65 wt %. Weight ratio of oxalic acid to non-polymer catechins: 0.

Oxalic Acid (Reagent, Product of Tokyo Kasei Kogyo Co., Ltd.)

<Production Process of the Packaged Beverages of Examples 1-5 and Comparative Examples 1-3>

Each packaged beverage was produced as will be described hereinafter. In accordance with the typical sport drink formulation shown in Table 1 or Table 2, the individual ingredients (weight parts) were combined together, and deionized water was then added to bring the total volume to 100 mL so that a mixed solution was prepared. Based on the Food Sanitation Act, sterilization and hot-pack filling were conducted to produce a packaged beverage. Ingredient data of the beverage are also shown.

An assessment was performed as to whether or not the objects of the present invention were achieved, specifically, a refreshing feeling specific to a sour taste derived from the sour seasoning was persistently available, the refreshing feeling did not become fuzzy even after long-term storage, and the beverage was deliciously drinkable even at room temperature.

Expert panelists were each requested to take 500 mL as desired, and subsequent to taking 500 mL, to score his or her assessment in accordance with the below-described standards. With respect to each beverage, two samples were employed in the test, one having been stored at 5° C. and the other having been stored at 37° C., both, for 2 months from immediately after the production of the beverage. The latter sample was assessed relative to the former sample. It is to be noted that the drinking temperature was room temperature. As a control, a similar drinking test was conducted using the beverages of the comparative examples.

Maintenance of refreshing feeling:

A Maintained

B Slightly maintained

C Somewhat lost

D Lost

In addition to the above-described assessment, another assessment was also performed on each beverage as to whether or not the persistence of a sour taste which is generally experienced from a catechins-free, packaged beverage when taken especially in a sport scene was reduced to give excellent mouth refreshment and the beverage had a taste suited as a beverage to be gulped down especially in the situation of a sport or the like, to say nothing about drinking in everyday life. Using sport drink users [ten (10) male volunteers in their twenties or thirties] in the habit of doing physical exercises, they were each requested to take 500 mL as desired in a sport scene (while playing tennis at a tennis court in summer), and subsequent to taking 500 mL, to score his assessment in accordance with the below-described standards. It is to be noted that the drinking temperature was surrounding temperature. As a control, a similar drinking test was conducted using the beverages of the comparative examples.

Pungency of sour taste to the throat:

A Weak

B Somewhat weak

C Slightly strong

D Strong

Mouth refreshment:

A Excellent

B Good

C Slightly poor

D Poor

Concerning the requirement that even in a form filled in an oxygen-permeable, clear container, the external appearance of a beverage is hardly altered in a storage test designed on the assumption that the beverage would be displayed in a shop window and would be exposed to lighting and therefore, is excellent in color tone stability under oxygen permeation or light exposure, each beverage filled in a clear PET (polyethylene terephthalate) bottle container of 500-mL capacity was stored at 15° C. for 20 days under exposure to 10,000-lux visible light, and after the storage, ten (10) expert panelists visually observed the beverage for any change in color tone and scored the observation results in accordance with the following standards.

A Not changed

B Slight changed

C Changed

D Substantially changed

As evident from Table 1 and Table 2, the beverages of the examples had a good sour taste and gave excellent mouth refreshment when taken while playing the sport. Further, the sour taste remained good even when stored over a long term, and the color tone was stable even when exposed to light under oxygen permeation.

### Examples 6-10 & Comparative Examples 4-6

The packaged beverage of each example or comparative example was produced by mixing the corresponding ingredients shown in Table 3 or Table 4 and then conducting predetermined post-treatment. It is to be noted that the purified products A to E of green tea extracts were the same as those employed in Tables 1 and 2.

TABLE 3

| | | Examples | | |
|---|---|---|---|---|
| | | 6 | 7 | 8 |
| Purified product (A) of green tea extract | | — | — | — |
| Concentrate (B) of green tea extract | | — | — | — |
| Purified product (C) of green tea extract | | 0.08 | 0.68 | 0.08 |
| Purified product (D) of green tea extract | | — | — | — |
| Purified product (E) of green tea extract | | — | — | — |
| Oxalic acid | | — | — | — |
| Ascorbic acid | | 0.03 | 0.03 | 0.03 |
| Sour seasoning | | 0.3 | 0.3 | 0.3 |
| Fructose-glucose liquid sugar | | — | — | — |
| Honey | | — | — | — |
| Fructose | | 5.0 | 16.0 | 0.1 |
| Glucose | | — | — | — |
| Stevia | | — | — | — |
| Artificial sweetener | | 0.1 | 5.0 | 5.0 |
| Minerals | | 0.07 | 0.07 | 0.07 |
| Cyclic oligosaccharide | | — | — | — |
| Fruit juice | | — | — | — |
| Flavoring | | 0.10 | 0.10 | 0.10 |
| Vitamins A, B, E | | — | — | — |
| Deionized water | | Balance | Balance | Balance |
| Total amount | | 100 | 100 | 100 |
| pH of Beverage | | 3.5 | 3.5 | 3.5 |
| Non-polymer catechins (wt %) | | 0.065 | 0.55 | 0.065 |
| Caffeine/non-polymer catechins ratio | | 0.00001 | 0.00001 | 0.00001 |
| Oxalic acid/non-polymer catechins ratio | | 0.00001 | 0.00001 | 0.00001 |
| Preparation | Oxalic acid/non-polymer catechins | 0.00001 | 0.00001 | 0.00001 |
| | ratio | | | |
| | Equivalent glucose amount (wt %) | ND | ND | ND |
| | Equivalent fructose amount (wt %) | 5.0 | 16.0 | 0.1 |
| | Na amount in beverage (mg/100 mL) | 47 | 47 | 47 |
| | K amount in beverage (mg/100 mL) | 6 | 6 | 6 |

| | | | |
|---|---|---|---|
| Percentage of epi-form catechins | 0.90 | 0.90 | 0.90 |
| Haze value of beverage | 55 | 50 | 56 |
| Absence of disagreeable taste from the middle | A | A | A |
| of taking the beverage after its long-term | | | |
| storage | | | |
| Mouth refreshment when taken while playing a | A | A | A |
| sport | | | |
| Relievability of thirst when taken while playing | A | A | A |
| a sport | | | |
| Color tone stability when exposed to light under | A | A | A |
| oxygen permeation | | | |

Examples

| | | 9 | 10 |
|---|---|---|---|
| Purified product (A) of green tea extract | | — | — |
| Concentrate (B) of green tea extract | | — | — |
| Purified product (C) of green tea extract | | — | 0.16 |
| Purified product (D) of green tea extract | | — | — |
| Purified product (E) of green tea extract | | 0.12 | — |
| Oxalic acid | | — | — |
| Ascorbic acid | | 0.03 | 0.03 |
| Sour seasoning | | 0.15 | 0.5 |
| Fructose-glucose liquid sugar | | — | — |
| Honey | | — | — |
| Fructose | | 0.1 | 0.1 |
| Glucose | | — | 0.04 |
| Stevia | | — | — |
| Artificial sweetener | | 5.0 | 5.0 |
| Minerals | | 0.07 | 0.07 |
| Cyclic oligosaccharide | | — | — |
| Fruit juice | | — | — |
| Flavoring | | 0.10 | 0.10 |
| Vitamins A, B, E | | — | — |
| Deionized water | | Balance | Balance |
| Total amount | | 100 | 100 |
| pH of Beverage | | 3.7 | 3.4 |
| Non-polymer catechins (wt %) | | 0.12 | 0.13 |
| Caffeine/non-polymer catechins ratio | | 0 | 0.00001 |
| Oxalic acid/non-polymer catechins ratio | | 0 | 0.00001 |
| Preparation | Oxalic acid/non-polymer catechins | 0 | 0.00001 |
| | ratio | | |
| | Equivalent glucose amount (wt %) | ND | 0.04 |
| | Equivalent fructose amount (wt %) | 0.1 | 0.1 |
| | Na amount in beverage (mg/100 mL) | 47 | 47 |
| | K amount in beverage (mg/100 mL) | 6 | 6 |

| | | |
|---|---|---|
| Percentage of epi-form catechins | 1.0 | 1.0 |
| Haze value of beverage | 53 | 53 |
| Absence of disagreeable taste from the middle | A | A |
| of taking the beverage after its long-term | | |
| storage | | |
| Mouth refreshment when taken while playing a | A | A |
| sport | | |
| Relievability of thirst when taken while playing | A | A |
| a sport | | |
| Color tone stability when exposed to light under | A | A |
| oxygen permeation | | |

TABLE 4

| | | Comparative Examples | | |
|---|---|---|---|---|
| | | 4 | 5 | 6 |
| Purified product (A) of green tea extract | | — | 1.00 | — |
| Concentrate (B) of green tea extract | | — | — | 0.15 |
| Purified product (C) of green tea extract | | — | — | 0.97 |
| Purified product (D) of green tea extract | | 0.03 | — | — |
| Oxalic acid | | — | — | — |
| Ascorbic acid | | 0.06 | 0.03 | 0.03 |
| Sour seasoning | | 0.05 | 0.3 | 0.3 |
| Fructose-glucose liquid sugar | | 6.0 | — | — |
| Honey | | — | — | — |
| Fructose | | — | 0.1 | 0.1 |
| Glucose | | — | — | — |
| Stevia | | — | — | — |
| Artificial sweetener | | — | 5.0 | 5.0 |
| Minerals | | 0.10 | 0.07 | 0.07 |
| Cyclic oligosaccharide | | 0.2 | — | — |
| Fruit juice | | 0.06 | — | — |
| Flavoring | | 0.10 | 0.10 | 0.10 |
| Vitamins A, B, E | | 0.2 | — | — |
| Deionized water | | Balance | Balance | Balance |
| Total amount | | 100 | 100 | 100 |
| pH of Beverage | | 3.5 | 3.5 | 3.5 |
| Non-polymer catechins (wt %) | | 0.02 | 0.22 | 0.79 |
| Caffeine/non-polymer catechins ratio | | 0.003 | 0.05 | 0.0011 |
| Oxalic acid/non-polymer catechins ratio | | 0.00001 | 0.01 | 0.0004 |
| Preparation | Oxalic acid/non-polymer catechins | 0.00001 | 0.01 | 0.0004 |
| | ratio | | | |
| | Equivalent glucose amount (wt %) | 3.0 | ND | ND |
| | Equivalent fructose amount (wt %) | 3.0 | 0.1 | ND |
| | Na amount in beverage (mg/100 mL) | 32 | 47 | 47 |
| | K amount in beverage (mg/100 mL) | 21 | 44 | 20 |

| | | | |
|---|---|---|---|
| Percentage of epi-form catechins | 0.90 | 0.89 | 0.87 |
| Haze value of beverage | 60 | 0.02 | 0.02 |
| Absence of disagreeable taste from the middle | D | D | C |
| of taking the beverage after its long-term | | | |
| storage | | | |
| Mouth refreshment when taken while playing a | D | D | D |
| sport | | | |
| Relievability of thirst when taken while playing | C | D | D |
| a sport | | | |
| Color tone stability when exposed to light under | C | D | D |
| oxygen permeation | | | |

<Production Process of the Packaged Beverages of Examples 6-10 and Comparative Examples 4-6>

Each packaged beverage was produced as will be described hereinafter. In accordance with the typical sport drink formulation shown in Table 3 or Table 4, the individual ingredients (weight parts) were combined together, and deionized water was then added to bring the total volume to 100 mL so that a mixed solution was prepared. Based on the Food Sanitation Act, sterilization and hot-pack filling were conducted to produce a packaged beverage. Ingredient data of the beverage are also shown.

An assessment was performed as to whether or not the objects of the present invention were achieved, specifically, the beverage was free of any persisting disagreeable aftertaste generally experienced from the middle of taking a beverage after long-term storage and was deliciously drinkable even at room temperature.

Expert panelists were each requested to take 500 mL as desired, and subsequent to taking 500 mL, to score his or her assessment in accordance with the below-described standards. With respect to each beverage, two samples were employed in the test, one having been stored at 5° C. and the other having been stored at 37° C., both, for 2 months from immediately after the production of the beverage. The latter sample was assessed relative to the former sample. It is to be noted that the drinking temperature was room temperature. As a control, a similar drinking test was conducted using the beverages of the comparative examples.

Absence of any persisting disagreeable aftertaste generally experienced from the middle of taking a beverage after long-term storage:

A No persisting disagreeable aftertaste

B Slight persisting disagreeable aftertaste

C Persisting disagreeable aftertaste

D Strong persisting disagreeable aftertaste

In addition to the above-described assessment, another assessment was also performed on each beverage as to whether or not the beverage is excellent in mouth refreshment especially when taken in a sport scene and with respect to the relievability of thirst, the beverage has a taste suited as a beverage to be gulped down especially in the situation of a sport of the like. Using sport drink users [ten (10) male volunteers in their twenties or thirties] in the habit of doing physical exercises, they were each requested to take 500 mL as desired in a sport scene (while playing tennis at a tennis court in summer), and subsequent to taking 500 mL, to score his assessment in accordance with the below-described standards. It is to be noted that the drinking temperature was surrounding temperature. As a control, a similar drinking test was conducted using the beverages of the comparative examples.

Mouth refreshment while playing the sport:

A Excellent

B Good

C Slightly poor

D Poor

Relievability of thirst while playing the sport:

A Excellent

B Good

C Slightly poor

D Poor

Concerning the requirement that even in a form filled in an oxygen-permeable, clear container, the external appearance of a beverage is hardly altered in a storage test designed on the assumption that the beverage would be displayed in a shop window and would be exposed to lighting and therefore, is excellent in color tone stability under oxygen permeation or light exposure, each beverage filled in a clear PET (polyethylene terephthalate) bottle container of 500-mL capacity was stored at 15° C. for 20 days under exposure to 10,000-lux visible light, and after the storage, ten (10) expert panelists visually observed the beverage for any change in color tone and scored the observation results in accordance with the following standards.

A Not changed

B Slight changed

C Changed

D Substantially changed

### Examples 11-14 & Comparative Examples 7-8

The packaged beverage of each example or comparative example was produced by mixing the corresponding ingredients shown in Table 5 or Table 6 and then conducting predetermined post-treatment.

TABLE 5

| | | Examples | | | Example |
|---|---|---|---|---|---|
| | | 11 | 12 | 13 | 14 |
| Purified product (F) of green tea extract (*6) | | — | — | 0.13 | — |
| Concentrate (G) of green tea extract (*7) | | — | — | — | — |
| Purified product (H) of green tea extract (*8) | | 0.08 | 0.68 | 0.2 | — |
| Purified product (I) of green tea extract (*9) | | — | — | — | — |
| Purified product (J) of green tea extract (*10) | | — | — | — | 0.12 |
| Ascorbic acid | | 0.03 | 0.03 | 0.03 | 0.03 |
| Sour seasoning | | 0.3 | 0.7 | 0.3 | 0.05 |
| Fructose-glucose liquid sugar | | — | — | — | — |
| Glucose | | — | 17 | — | — |
| Artificial sweetener | | 5.0 | 1.0 | 5.0 | 5.0 |
| Minerals | | 0.07 | 0.07 | 0.07 | 0.07 |
| Cyclic oligosaccharide | | — | — | — | — |
| Fruit juice | | — | — | 0.05 | 0.05 |
| Emulsified flavoring (flavor) (*11) | | 0.05 | 0.05 | 0.05 | 0.05 |
| Non-emulsified flavoring (flavor) (*12) | | 0.05 | 0.05 | 0.05 | 0.05 |
| Vitamins A, B, E | | — | — | — | — |
| Deionized water | | Balance | Balance | Balance | Balance |
| Total amount | | 100 | 100 | 100 | 100 |
| pH of Beverage | | 3.5 | 3.5 | 3.5 | 3.5 |
| Non-polymer catechins (wt %) | | 0.065 | 0.55 | 0.19 | 0.12 |
| Quinic acid/non-polymer catechins ratio | | 0.00001 | 0.00001 | 0.003 | 0 |
| Preparation | Quinic acid/non-polymer catechins | 0.00001 | 0.00001 | 0.003 | 0 |
| | ratio | | | | |
| | Oxalic acid/non-polymer catechins | 0.00001 | 0.00001 | 0.0015 | 0 |
| | ratio | | | | |
| | Equivalent glucose amount (wt %) | — | — | — | — |
| | Equivalent fructose amount (wt %) | — | — | — | — |
| | Na amount in beverage (mg/100 mL) | 47 | 47 | 47 | 47 |
| | K amount in beverage (mg/100 mL) | 6 | 6 | 6 | 6 |

| | | | | |
|---|---|---|---|---|
| Percentage of epi-form catechins | 0.90 | 0.90 | 0.90 | 1.0 |
| Haze value of beverage | 55 | 50 | 54 | 53 |
| Sour taste after long-term storage | A | A | A | A |
| Sour taste when taken while playing a sport | A | A | A | A |
| Color tone stability when exposed to light under | A | A | A | A |
| oxygen permeation | | | | |

TABLE 6

| | | Comparative | |
|---|---|---|---|
| | | Examples | |
| | | 7 | 8 |
| Purified product (F) of green tea extract (*6) | | — | 1.00 |
| Concentrate (G) of green tea extract (*7) | | — | — |
| Purified product (H) of green tea extract (*8) | | — | — |
| Purified product (I) of green tea extract (*9) | | 0.03 | — |
| Ascorbic acid | | 0.06 | 0.03 |
| Sour seasoning | | 0.05 | 0.3 |
| Fructose-glucose liquid sugar | | 6.0 | — |
| Glucose | | — | — |
| Artificial sweetener | | — | 5.00 |
| Minerals | | 0.10 | 0.07 |
| Cyclic oligosaccharide | | 0.2 | — |
| Fruit juice | | 0.06 | — |
| Emulsified flavoring (flavor) (*11) | | 0 | 0 |
| Non-emulsified flavoring (flavor) (*12) | | 0.10 | 0.10 |
| Vitamins A, B, E | | 0.2 | — |
| Deionized water | | Balance | Balance |
| Total amount | | 100 | 100 |
| pH of Beverage | | 3.5 | 3.5 |
| Non-polymer catechins (wt %) | | 0.02 | 0.22 |
| Quinic acid/non-polymer catechins ratio | | 0.00001 | 0.02 |
| Preparation | Quinic acid/non-polymer catechins | 0.00001 | 0.02 |
| | ratio | | |
| | Oxalic acid/non-polymer catechins | 0.00001 | 0.01 |
| | ratio | | |
| | Equivalent glucose amount (wt %) | 3.0 | — |
| | Equivalent fructose amount (wt %) | 3.0 | — |
| | Na amount in beverage (mg/100 mL) | 32 | 47 |
| | K amount in beverage (mg/100 mL) | 21 | 44 |

| | | |
|---|---|---|
| Percentage of epi-form catechins | 0.90 | 0.89 |
| Haze value of beverage | 60 | 0.02 |
| Sour taste after long-term storage | D | D |
| Sour taste when taken while playing a sport | D | D |
| Color tone stability when exposed to light under | D | D |
| oxygen permeation | | |

(*6) Purified Product F of Green Tea Extract

“POLYPHENON™ HG” (100 g, product of Tokyo Food Techno Co., Ltd.) was suspended as a concentrate of green tea extract in a 95% aqueous solution of ethanol (490.9 g) under stirring at room temperature and 250 rpm. After activated carbon “KURARAY COAL™ GLC” (20 g, product of Kuraray Chemical K.K.) and acid clay “MIZKA ACE™ #600” (35 g, product of Mizusawa Chemical Industries, Ltd.) were poured, the resulting mixture was continuously stirred for about 10 minutes. Subsequent to the dropwise addition of a 40% aqueous solution of ethanol (409.1 g) over 10 minutes, stirring was continued for about 30 minutes still at room temperature. After the activated carbon and a precipitate were filtered off by No. 2 filter paper, the filtrate was filtered again through a 0.2 μm membrane filter. Finally, deionized water (200 g) was added to the filtrate, ethanol was distilled off at 40° C. and 0.0272 kg/cm² to obtain the product.

After the treatment, the content of non-polymer catechins was 22 wt %.

The weight ratio of quinic acid to non-polymer catechins after the treatment=0.02

The weight ratio of oxalic acid to non-polymer catechins after the treatment=0.01

(*7) Concentrate G of Green Tea Extract

Content of non-polymer catechins: 33.70 wt %. Percentage of gallates: 50.7 wt %. Weight ratio of quinic acid to non-polymer catechins: 0.16. Weight ratio of oxalic acid to non-polymer catechins: 0.06.

(*8) Purified Product H of Green Tea Extract

Content of non-polymer catechins: 81.4 wt %. Percentage of gallates: 65 wt %. Weight ratio of quinic acid to non-polymer catechins: 0.00001. Weight ratio of oxalic acid to non-polymer catechins: 0.00001.

(*9) Purified Product I of Green Tea Extract

Content of non-polymer catechins: 77.0 wt %. Percentage of gallates: 99 wt %. Weight ratio of quinic acid to non-polymer catechins: 0.00001. Weight ratio of oxalic acid to non-polymer catechins: 0.00001.

(*10) Purified Product J of Green Tea Extract

Reagents of epicatechins, epigallocatechins, epicatechingallates and epigallocatechingallates (products of Kurita Water Industries, Ltd.) were mixed into the purified product J. Content of non-polymer catechins: 99.0 wt %. Percentage of gallates: 65 wt %. Weight ratio of quinic acid to non-polymer catechins: 0. Weight ratio of oxalic acid to non-polymer catechins: 0.

(*11) Emulsified Flavoring: “Grape Fruit 106 JX”

(*12) Non-Emulsified Flavoring: Grape Fruit Flavor Quinic Acid, Oxalic Acid (Reagents, Products of Tokyo Kasei Kogyo Co., Ltd.)

<Production Process of the Packaged Beverages of Examples 11-14 and Comparative Examples 7-8>

Each packaged beverage was produced as will be described hereinafter. In accordance with the typical sport drink formulation shown in Table 5 or Table 6, the individual ingredients (weight parts) were combined together, and deionized water was then added to bring the total volume to 100 mL so that a mixed solution was prepared. Based on the Food Sanitation Act, sterilization and hot-pack filling were conducted to produce a packaged beverage. Ingredient data of the beverage are also shown.

An assessment was performed as to whether or not the objects of the present invention were achieved, specifically, a refreshing feeling specific to a sour taste derived from the sour seasoning was persistently available, the refreshing feeling did not become fuzzy even after long-term storage, and the beverage was deliciously drinkable even at room temperature.

Expert panelists were each requested to take 500 mL as desired, and subsequent to taking 500 mL, to score his or her assessment in accordance with the below-described standards. With respect to each beverage, two samples were employed in the test, one having been stored at 5° C. and the other having been stored at 37° C., both, for 2 months from immediately after the production of the beverage. The latter sample was assessed relative to the former sample. It is to be noted that the drinking temperature was room temperature. As a control, a similar drinking test was conducted using the beverages of the comparative examples.

Maintenance of refreshing feeling:

A Maintained

B Slightly maintained

C Somewhat lost

D Lost

In addition to the above-described assessment, another assessment was also performed on each beverage as to whether or not the persistence of a sour taste which is generally experienced from a catechins-free, packaged beverage when taken especially in a sport scene was reduced to give excellent mouth refreshment and the beverage had a taste suited as a beverage to be gulped down especially in the situation of a sport or the like, to say nothing about drinking in everyday life. Using sport drink users (ten (10) male volunteers in their twenties or thirties] in the habit of doing physical exercises, they were each requested to take 500 mL as desired in a sport scene (while playing tennis at a tennis court in summer), and subsequent to taking 500 mL, to score his assessment in accordance with the below-described standards. It is to be noted that the drinking temperature was surrounding temperature. As a control, a similar drinking test was conducted using the beverages of the comparative examples.

Pungency of sour taste to the throat:

A Weak

B Somewhat weak

C Slightly strong

D Strong

Mouth refreshment:

A Excellent

B Good

C Slightly poor

D Poor

Concerning the requirement that even in a form filled in an oxygen-permeable, clear container (oxygen permeability factor (room temperature): 0.04 mL/350 mL·day·atm), the external appearance of a beverage is hardly altered in a storage test (exposure test) designed on the assumption that the beverage would be displayed in a shop window and would be exposed to lighting and therefore, is excellent in color tone stability under oxygen permeation or light exposure, each beverage filled in a clear PET (polyethylene terephthalate) bottle container of 500-mL capacity was stored at 15° C. for 60 days under exposure to 10,000-lux visible light, and after the storage, ten (10) expert panelists visually observed the beverage for any change in color tone and scored the observation results in accordance with the following standards.

A Not changed

B Slight changed

C Changed

D Substantially changed

As evident from Table 5 and Table 6, the beverages of the examples had a good sour taste and gave excellent mouth refreshment when taken while playing the sport. Further, the sour taste remained good even when stored over a long term, and the color tone was stable even when exposed to light under oxygen permeation.

1. A non-tea-based, packaged beverage with a purified product of green tea extract added thereto, wherein said purified product comprises non-polymer catechins in solid constituents thereof and has a content weight ratio of (B) oxalic acid or a salt thereof to (A) said non-polymer catechins [(B)/(A)] in a range of from 0 to 0.002, and said non-tea-based, packaged beverage comprises the following ingredients (A) to (D)
(A) from 0.03 to 0.6 wt % of non-polymer catechins,
(B) oxalic acid or a salt thereof at an ingredient (B)/ingredient (A) of from 0 to 0.02,
(C) caffeine at an ingredient (C)/ingredient (A) weight ratio of from 0 to 0.16, and
(D) from 0.03 to 1.0 wt % of a sour seasoning, and has a pH of from 2 to 6.

2. The non-tea-based, packaged beverage according to claim 1, further comprising from 0.001 to 0.2 wt % of sodium ions and from 0.001 to 0.1 wt % of potassium ions.

3. The non-tea-based, packaged beverage according to claim 1 or 2, further comprising from 0.0001 to 20 wt % of a sweetener.

4. The non-tea-based, packaged beverage according to any one of claims 1-3, wherein said content weight ratio of (B) oxalic acid or a salt thereof to (A) non-polymer catechins [(B)/(A)] is from 0 to 0.002.

5. The non-tea-based, packaged beverage according to any one of claims 1-4, wherein said content weight ratio of (C) caffeine to (A) non-polymer catechins [(C)/(A)] is from 0 to 0.09.

6. The non-tea-based, packaged beverage according to any one of claims 1-5, wherein said purified product of said green tea extract is one obtained by removing caffeine such that said content weight ratio of (C) caffeine to (A) non-polymer catechins [(C)/(A)] falls within a range of from 0 to 0.09.

7. The non-tea-based, packaged beverage according to any one of claims 1-6 as filled in an oxygen-permeable container.

8. The non-tea-based, packaged beverage according to any one of claims 1-7 as filled in a clear container.

9. The non-tea-based, packaged beverage according to any one of claims 1-8, wherein said beverage has a pH of from 3 to 6.

10. The non-tea-based, packaged beverage according to any one of claims 1-9, wherein said beverage has a turbidity of from 0.1 to 80.

11. A non-tea-based, packaged beverage with a purified product of green tea extract added thereto, wherein said purified product comprises non-polymer catechins in solid constituents thereof and has a content weight ratio of (B) oxalic acid or a salt thereof to (A) non-polymer catechins [(B)/(A)] in a range of from 0 to 0.002, and said non-tea-based, packaged beverage comprises the following ingredients (A) to (C) and (E)
(A) from 0.03 to 0.6 wt % of non-polymer catechins,
(B) oxalic acid or a salt thereof at an ingredient (B)/ingredient (A) weight ratio of from 0 to 0.02,
(C) caffeine at an ingredient (C)/ingredient (A) weight ratio of from 0 to 0.16, and
(E) from 0.001 to 15 wt %, in terms of fructose equivalent amount, and from 0 to less than 0.05 wt %, in terms of glucose equivalent amount, of a carbohydrate.

12. The non-tea-based, packaged beverage according to claim 11, further comprising from 0.001 to 0.2 wt % of sodium ions and from 0.001 to 0.1 wt % of potassium ions.

13. The non-tea-based, packaged beverage according to claim 11 or 12, wherein said beverage has a pH of from 2 to 6.

14. The non-tea-based, packaged beverage according to any one of claims 11-13, wherein said content weight ratio of (B) oxalic acid or a salt thereof to (A) non-polymer catechins [(B)/(A)] is from 0 to 0.002.

15. The non-tea-based, packaged beverage according to any one of claims 11-14, wherein said content weight ratio of (C) caffeine to (A) non-polymer catechins [(C)/(A)] is from 0 to 0.09.

16. The non-tea-based, packaged beverage according to any one of claims 11-15, wherein said purified product is one obtained by removing caffeine such that said content weight ratio of (C) caffeine to (A) non-polymer catechins [(C)/(A)] falls within a range of from 0 to 0.09.

17. The non-tea-based, packaged beverage according to any one of claims 11-16 as filled in an oxygen-permeable container.

18. The non-tea-based, packaged beverage according to any one of claims 11-17 as filled in a clear container.

19. The non-tea-based, packaged beverage according to any one of claims 11-18, wherein said beverage has a turbidity of from 0.1 to 80.

20. A process for producing a non-tea-based, packaged beverage comprising the following ingredients (A) to (C) and (E):
(A) from 0.03 to 0.6 wt % of non-polymer catechins,
(B) oxalic acid or a salt thereof at an ingredient (B)/ingredient (A) weight ratio of from 0 to 0.02,
(C) caffeine at an ingredient (C)/ingredient (A) weight ratio of from 0 to 0.16, and
(E) from 0.001 to 15 wt %, in terms of fructose equivalent amount, and from 0 to less than 0.05 wt %, in terms of glucose equivalent amount, of a carbohydrate, which comprises:
adding a green tea extract comprising non-polymer catechins in solid constituents thereof and having a content weight ratio of (B) oxalic acid or a salt thereof to (A) non-polymer catechins [(B)/(A)] in a range of from 0 to 0.002.

21. A non-tea-based, packaged beverage with a purified product of green tea extract added thereto, wherein said purified product comprises non-polymer catechins in solid constituents thereof and has a content weight ratio of (F) quinic acid or a salt thereof to (A) said non-polymer catechins [(F)/(A)] in a range of from 0 to 0.018, and said non-tea-based, packaged beverage comprises the following ingredients:
(A) from 0.03 to 0.6 wt % of non-polymer catechins,
(F) quinic acid or a salt thereof at an ingredient (F)/ingredient (A) weight ratio of from 0 to 0.2,
(I) from 0.0001 to 20 wt % of a sweetener,
(D) from 0.03 to 1.0 wt % of a sour seasoning,
(G) from 0.0001 to 0.2 wt % of sodium ions, and
(H) from 0.0001 to 0.1 wt % of potassium ions, and has a pH of from 2 to 6.

22. The non-tea-based, packaged beverage according to claim 21 as filled in an oxygen-permeable container having an oxygen permeability constant of not greater than 0.1 mL/350 mL·day·atom.

23. The non-tea-based, packaged beverage according to claim 21 or 22, wherein said beverage has a turbidity of from 0.1 to 80.

24. The non-tea-based, packaged beverage according to any one of claims 21-23, further comprising an emulsified flavor as a flavoring.

25. The non-tea-based, packaged beverage according to any one of claims 21-24, wherein said content weight ratio of (F) quinic acid or a salt thereof to (A) non-polymer catechins [(F)/(A)] is from 0.00005 to 0.018.

26. The non-tea-based, packaged beverage according to any one of claims 21-25, wherein said purified product of green tea extract is one obtained by removing oxalic acid or said salt thereof such that said content weight ratio of (B) oxalic acid or said salt thereof to (A) non-polymer catechins [(B)/(A)] falls within a range of from 0 to 0.002.

27. The non-tea-based, packaged beverage according to any one of claims 21-26, wherein said sweetener is an artificial sweetener.

28. The non-tea-based, packaged beverage according to any one of claims 21-27 as filled in a clear container.

29. The non-tea-based, packaged beverage according to any one of claims 21-28, wherein said beverage has a pH of from 3 to 6.
